(19) United States
(12) Patent Application Publication
(10) Pub. No.: US 2026/0342539 A1
(43) Pub. Date: Oct. 29, 2026

(54) UPLOAD OF MOTHERBOARD REPLACEMENT VOUCHERS FOR AIR-GAPPED VOUCHER SERVICE

(71) Applicant: Dell Products L.P., Round Rock, TX (US)

(72) Inventors: Eric Bruno, Shirley, NY (US); Ravinder Tamishetty, Singapore (SG); Mahesh Babu Ramaiah, Bangalore (IN); Xingyu Wang, Singapore (SG)

(73) Assignee: Dell Products L.P., Round Rock, TX (US)

(21) Appl. No.: 19/189,630

(22) Filed: Apr. 25, 2025

(51) Int. Cl. H04L 9/08; H04L 9/32

(52) U.S. Cl. CPC H04L 9/0819; H04L 9/3213

(57) ABSTRACT

A system and method are disclosed for securely managing device ownership vouchers in air-gapped environments, particularly during motherboard and Trusted Platform Module (TPM) replacement. The invention enables secure transfer of cryptographic keys and vouchers between a control plane and a voucher service without a direct network connection. Using a three-stage process, the system facilitates control plane installation, manufacturer keypair setup, creation of new vouchers during device initialization recovery, and secure transfer of vouchers back to the control plane. The process employs the Diffie-Hellman key exchange algorithm to generate a symmetric cryptographic key for encrypting and transferring manufacturer keypairs. New vouchers are linked to original voucher Global Unique Identifiers (GUIDs) for enhanced tracking and security. This invention ensures secure device credential recovery, robust voucher generation, and improved traceability in air-gapped environments.

### BACKGROUND

As the value and use of information continues to increase, individuals and businesses seek additional ways to process and store information. One option is an Information Handling System (IHS). An IHS generally processes, compiles, stores, or communicates information or data for business, personal, or other purposes. Technology and information handling needs and requirements can vary between different applications. Thus, IHSs can also vary regarding what information is handled, how the information is handled, how much information is processed, stored, or communicated, and how quickly and efficiently the information can be processed, stored, or communicated. The variations in IHSs allow systems to be general or configured for a specific user or specific use such as financial transaction processing, airline reservations, enterprise data storage, internet of things (IOT) monitoring and communications, or global communications. In addition, IHSs can include a variety of hardware and software resources that can be configured to process, store, and communicate information and can include one or more computer systems, graphics interface systems, data storage systems, and networking systems. IHSs can also implement various virtualized architectures. Data communications among information handling systems may be via networks that are wired, wireless, optical or some combination. IHSs can be used in a distributed environment as edge devices. Example edge devices include applications running in a retail store, such as point of sale device, a gateway, a compute or storage device not operating in a datacenter, remote industrial sensor and monitoring equipment, or deployed telecommunications equipment.

### SUMMARY

Embodiments are directed to methods and systems for securely managing device ownership vouchers in air-gapped environments, particularly when a device’s motherboard and Trusted Platform Module (TPM) are replaced. The solution addresses the challenge of securely transferring cryptographic keys and vouchers between a control plane and a voucher service without a direct network connection. The process involves three stages: (1) installation of the control plane and setup of the manufacturer service, including secure transfer of a manufacturer keypair using the Diffie-Hellman key exchange algorithm; (2) creation and upload of a new voucher during device initialization recovery after motherboard replacement; and (3) transfer of the new voucher back to the control plane to complete the recovery process. The new voucher is linked to the original voucher's Global Unique Identifier (GUID) for tracking and security purposes. This invention enables secure motherboard replacement in air-gapped environments, enhances voucher generation security by assigning unique manufacturer keypairs to user accounts, and improves traceability for reselling scenarios. It ensures robust recovery of device credentials while maintaining strict network isolation.

In an example embodiment, a method comprises generating a symmetric cryptographic key over a public channel between a control plane and a voucher service, generating a manufacturer keypair by the voucher service, encrypting the manufacturer keypair using the symmetric cryptographic key by the voucher service, transferring an encrypted manufacturer keypair from the voucher service to the control plane, and decrypting the encrypted manufacturer keypair by the control plane using the symmetric cryptographic key. The voucher service and the control plane are air gapped and the encrypted manufacturer keypair may be transferred via email.

The method may further comprise replacing the motherboard on a device, and creating, by a manufacturer service on the control plane, a new voucher for the device. The new voucher is associated with a replacement motherboard. The new voucher is uploaded from the control plane to the voucher service, which identifies an original voucher associated with the device and attaches an original voucher identifier to the new voucher.

The method may further comprise installing a control plane by a user. The user then receives an access token from the control plane and uploads the control plane access token to the voucher service as a voucher download request. The user then receives a voucher from the voucher service and uploads the voucher to the control plane to complete a device initialization recovery. The voucher may be received by the user via email. The voucher is associated with a device having a replacement motherboard and includes an original voucher identifier associated with the device prior to the motherboard replacement.

### BRIEF DESCRIPTION OF THE DRAWINGS

Having thus described the invention in general terms, reference will now be made to the accompanying drawings, which are not necessarily drawn to scale, and wherein:

FIG. 1 is block diagram illustrating components involved with FIDO device onboarding and initialization.

FIGS. 2A and 2B illustrate a process for device initialization recovery after the device credentials have been changed, such as due to a motherboard replacement.

FIG. 3 illustrates a process for securely transferring the manufacturer keypair from a voucher service to a control plane.

FIG. 4 shows an example of an IHS configured to implement systems and methods as described herein for upload of motherboard replacement vouchers for an air-gapped voucher service.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

The embodiments disclosed herein enable voucher uploading from a control plane to a voucher service when the control plane is in an air-gapped site that has no direct network connection to the voucher service.

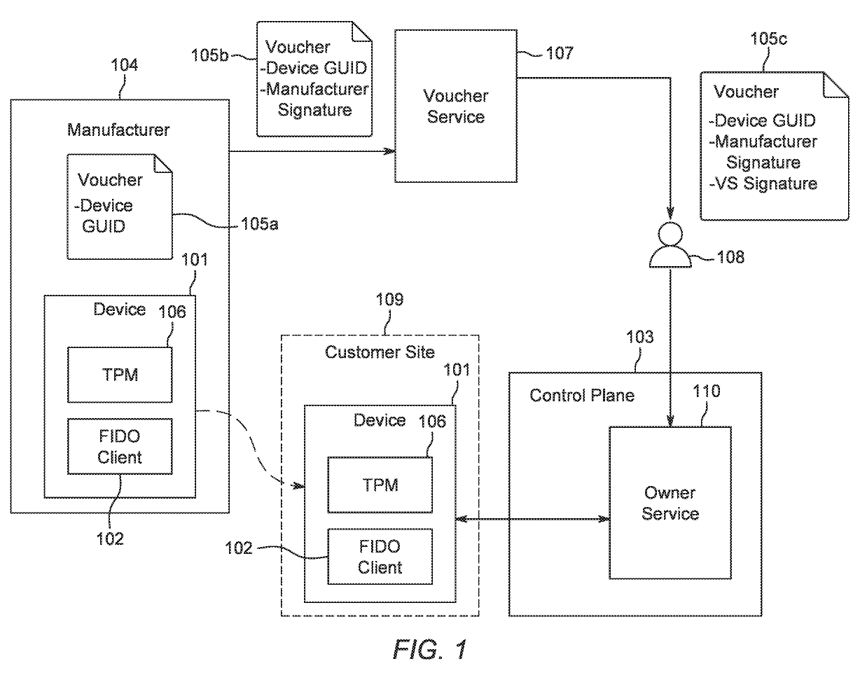

FIG. 1 is block diagram illustrating components involved with Fast IDentity Online (FIDO) device onboarding and initialization. A device 101 has a FIDO client 102 that is used for device onboarding to a control plane 103. A device manufacturer 104 creates an initial ownership voucher 105a for device 101. Voucher 105a includes device keys and certificates associated with device 101. The device keys are stored on device 101 in a Trusted Platform Module (TPM) 106, which is a specialized security chip built into the device motherboard. The original voucher 105a includes a Global Unique Identifier (GUID), such as a 128-bit text string, that uniquely identifies device 101.

The manufacturer 104 signs the initial voucher 105a and sends a signed voucher 105b to a voucher service 107. The voucher service 107 is an intermediate step, such as a device distributor, that transfers ownership of the device 101 to final owner or customer 108. When ownership of device 101 is transferred to owner 108, such as by shipping the device to a customer location 109, the device voucher 105b is further signed by the voucher service 107 and the signed voucher 105c is sent to owner 108. The owner 108 then uses device voucher 105c to onboard device 101 to an owner service 110 on control plane 103.

After device 101 is installed at a customer location, it may require upgrades or may experience hardware failure or damage. This can result in the replacement of the device motherboard along with the TPM 106. Because the device’s FIDO credentials are bound to secure hardware, such as TPM 106, replacement of the motherboard will result in the device losing the original credentials, such as device keys. Instead, the new motherboard will have its own set of keys stored on a new TPM. However, the new credentials will no longer match the device keys listed in voucher 105c, which is held by the owner 108 and used by owner service 110. So, the new credentials must be added to the owner voucher 105c to allow device 101 with the new motherboard to work with owner service 110.

The typical device initialization process builds device credentials in the manufacturer’s factory 104 using a manufacturing key. However, when the motherboard is replaced, device 101 has already left the factory 104 and was deployed at customer site 110. So, device initialization cannot be accomplished in the usual manner for the new motherboard and TPM. In the process disclosed herein, a control plane manufacturer service is created to simulate the manufacturer’s factory service 104 and to recover the device credentials.

A new voucher needs to be created for the new motherboard. The new voucher has credentials that are paired with credentials in a new TPM and that identify the new motherboard. The new voucher needs to be uploaded to voucher service 107 so that it can be shared to the owner 108 and other services. However, if there is not an active connection between the voucher service 107 and the control plane 103 (i.e., if the control plane 103 and the voucher service 107 are air gapped), then the process disclosed herein can be used to securely exchange device credentials. As used herein, an air gap refers to a network security measure to ensure that a secure computer network is physically isolated from unsecured networks, such as the public Internet or an unsecured local area network. Air gaps may be used, for example, by organizations to prevent malicious actors from causing irreparable harm to digital assets and to protect classified, confidential, and proprietary information.

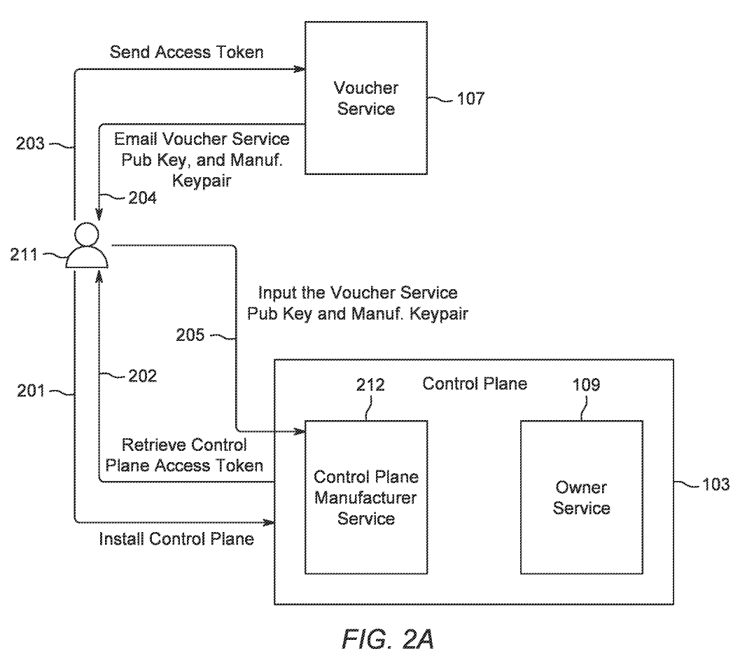

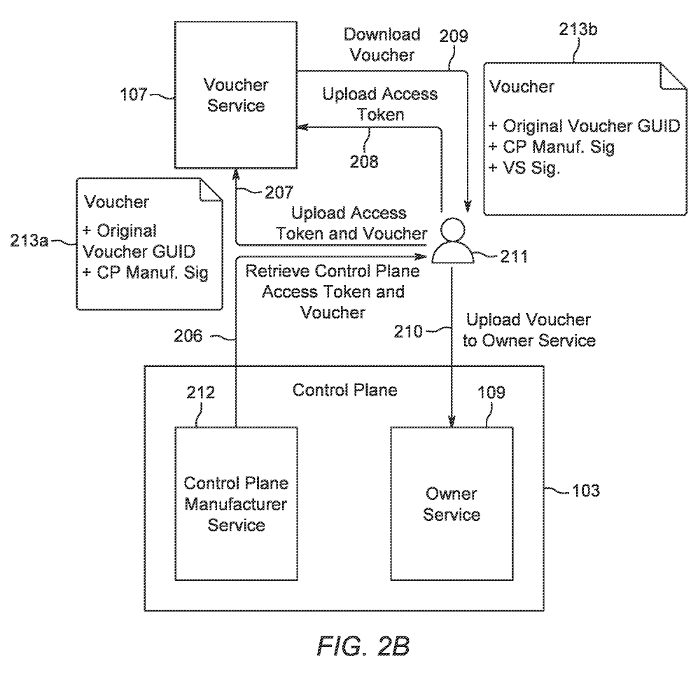

FIGS. 2A and 2B illustrate a process for device initialization (DI) recovery after the device credentials have been changed, such as due to a motherboard replacement. The process involves three stages. The first stage, shown in FIG. 2A, is Edge Orchestrator (EO) installation and Manufacturer Service setup. In step 201, a user 211, such as the owner of device 101, installs the control plane 103, which has a control plane manufacturer service 212. In step 202, the user 211 retrieves an EO access token from control plane 103. The access token contains a control plane identifier that can be used by the voucher service 107 to link the user’s 211 account information. In step 203, the user 211 accesses an API or user interface (UI) to send a request to voucher service 107 for manufacturer keypair generation using the access token. The voucher service 107 uses the EO access token to generate a manufacturer keypair into a secured storage. The voucher service 107 links the manufacturer keypair to the user’s 211 account.

In step 204, the voucher service 107 sends, such as by email, the manufacturer keypair and the voucher service’s public key to user 211. In step 205, the user uploads the voucher service public key and the manufacturer keypair to the manufacturer service 212 on control plane 103 as a manufacturer service setup request. The manufacturer service 212 saves the manufacturer keypair and the voucher service public key in a secure storage.

Referring to FIG. 2B, the second stage is voucher upload during DI recovery. During motherboard replacement, the device will communicate with the manufacturer service 212 in control plane 103 to create a new voucher 213a associated with the new motherboard. The manufacturer service 212 will extend the voucher 213a with the voucher service public key and will sign the voucher 213a with the manufacturer service private key. In step 206, the user 211 downloads the voucher 213a along with the EO access token. In step 207, user 211 uploads the voucher 213a and the EO access token to voucher service 107 as a voucher upload request. When voucher service 107 receives the new voucher 213a, it checks the original device voucher 105b (FIG. 1) that was assigned before the motherboard replacement and attaches the original voucher GUID to new voucher 213 for tracking purposes.

In the third stage, the new voucher is transferred back to the control plane. User 211 uses the normal process for transferring a voucher from voucher service 107 to control plane 103 to finish the DI recovery. In step 208, user 211 uploads the EO access token to voucher service 107 as a voucher download request. In step 209, voucher service 107 sends, such as by email, an extended voucher 213b to user 211. The extended voucher 213b includes the voucher service signature. In step 210, user 211 uploads extended voucher 213b to control plane 103 to complete the DI recovery.

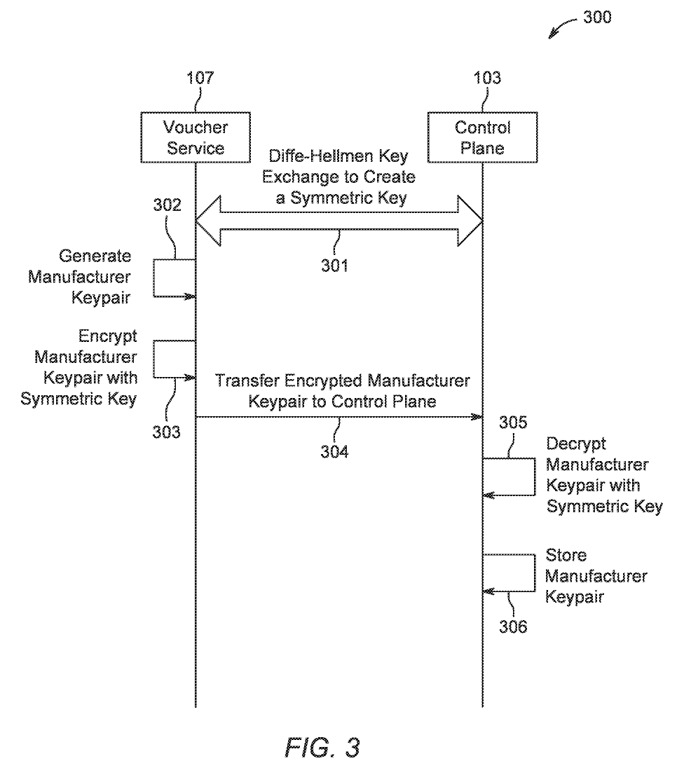

FIG. 3 illustrates a process 300 for securely transferring the manufacturer keypair from the voucher service 107 to the control plane 103 (e.g., the transfer described in steps 204, 205 above). This process 300 generates a symmetric key that is used to encrypt the manufacturer keypair. The symmetric key can also be used in the transfer of the replacement voucher from the voucher service 107 to the control plane 103. The control plane 103 creates the replacement voucher and uses the manufacturer keypair to sign the replacement voucher. To support the ability to use the voucher in the future if the control plane 103 loses the keypair, the manufacturer keypair must be created by the voucher service 107 and shared securely with the control plane 103.

In step 301, the voucher service 107 and the control plane 103 generate a symmetric key using the Diffie-Hellman key exchange algorithm. In step 302, the voucher service 107 generates the manufacturer keypair. In step 303, the voucher service 107 encrypts the manufacturer keypair with the symmetric key. In step 304, the voucher service 107 transfers the encrypted manufacturer keypair to the control plane 103. This transfer may be accomplished via email to a user or device owner in the situation where the voucher service 107 and control plane 103 are air gapped and do not have a secure direct connection.

In step 305, the control plane 103 decrypts the encrypted manufacturing keypair with the symmetric key it independently generated using the Diffie-Hellman key exchange algorithm in step 301. In step 306, the control plane 103 stores the decrypted manufacturing keypair in a manufacturer service vault. Once the manufacturing keypair is decrypted, the control plane 103 may delete the symmetric key, which is no longer needed.

This process enables motherboard replacement to be conducted in an air-gapped case where no secure connection has been established between the control plane and the voucher service. The voucher service assigns a manufacturer keypair to each user account and securely transfers the keypair to the control plane during control plane installation. This makes voucher generation more secure and more trackable. The replacement voucher tracks the original voucher GUID, which makes the voucher more secure for reselling cases.

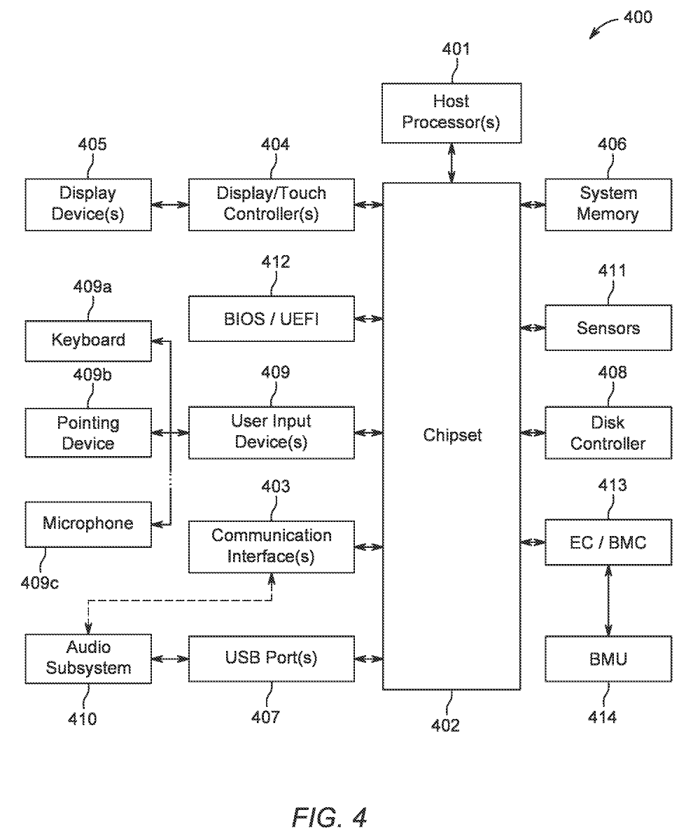

FIG. 4 shows an example of an Information Handling System (IHS) 400 configured to implement systems and methods as described herein for upload of motherboard replacement vouchers for an air-gapped voucher service. IHS 400 may be used as a device 101 or as a host for a control plane 103 or voucher service 107. Users 108 and 211 may use an IHS 400 to access the control plane 103 or voucher service 107.

As depicted, IHS 400 includes host processor(s) 401. In various embodiments, IHS 400 may be a single-processor system, or a multi-processor system including two or more processors. Host processor(s) 401 may include any processor capable of executing program instructions, such as an INTEL/AMD x76 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 400 includes chipset 402 coupled to host processor(s) 401. Chipset 402 may provide host processor(s) 401 with access to resources. In some cases, chipset 402 may utilize a QuickPath Interconnect (QPI) bus to communicate with host processor(s) 401. Chipset 402 may also be coupled to communication interface(s) 403 to enable communications between IHS 400 and various wired and/or wireless networks, such as Ethernet, WiFi (IEEE 802.11), Bluetooth (IEEE 802.15.1), cellular or mobile networks (e.g., Code-Division Multiple Access or “CDMA,” Time-Division Multiple Access or “TDMA,” Long-Term Evolution or “LTE,” etc.), satellite networks, or the like. Communication interface(s) 403 may be used to communicate with peripheral devices (e.g., Bluetooth speakers, microphones, headsets, etc.). Moreover, communication interface(s) 403 may be coupled to chipset 402 via a Peripheral Component Interconnect Express (PCIe) bus, or the like.

Chipset 402 may be coupled to display and/or touchscreen controller(s) 404, which may include one or more Graphics Processor Units (GPUs) on a graphics bus, such as an Accelerated Graphics Port (AGP) or PCIe bus. As shown, display controller(s) 404 provide video or display signals to one or more display device(s) 405. Display device(s) 405 may include Liquid Crystal Display (LCD), Light Emitting Diode (LED), Organic LED (OLED), or other thin film display technologies. Display device(s) 405 may include a plurality of pixels arranged in a matrix, configured to display visual information, such as text, two-dimensional images, video, three-dimensional images, etc. In some cases, display device(s) 405 may be provided as a single continuous display, rather than two discrete displays.

Chipset 402 may provide host processor(s) 401 and/or display controller(s) 404 with access to system memory 406. In various embodiments, system memory 406 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 402 may also provide host processor(s) 401 with access to one or more Universal Serial Bus (USB) ports/controllers 407, to which one or more peripheral devices may be coupled (e.g., integrated or external webcams, microphones, speakers, etc.).

Chipset 402 may further provide host processor(s) 401 with access to a disk controller 408, which may include a disk interface that connects the disc controller 408 to a Hard Disk Drive (HDD), an Optical Disk Drive (ODD), an SSD, and/or a disk emulator. The disk interface may include, for example, an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. The disk emulator may be provide an external interface that permits one or more hard disk drives, solid-state drives, optical drives, or other removable-media drives to be connected to IHS 400. An example of external interface includes a USB interface, an IEEE 1394 (Firewire) interface, a proprietary interface, or a combination thereof.

Chipset 402 may also provide access to one or more user input devices 409, for example, using a super I/O controller or the like. Examples of user input devices 409 include, but are not limited to, a keyboard 409a, pointing device 409b, such as a mouse, trackball, stylus, or active pen, and/or microphone(s) 409c. Other user input devices 409 (not shown) may include a camera, touchpad, totem, etc. Each user input device 409 may include a respective controller (e.g., a touchpad may have its own touchpad controller) that interfaces with chipset 402 through a wired or wireless connection, for example via communication interfaces(s) 403 and/or USB port(s) 407. Other input devices, such as keyboard 409a, may use a keyboard controller in an operating system.

In some cases, chipset 402 may also provide access to one or more output devices, such as an audio subsystem 410, speakers, headsets, video projectors, paper printers, 3D printers, Virtual/Augmented Reality (VR/AR) devices, etc. The output devices may be accessed, for example, via communication interfaces(s) 403 and/or USB port(s) 407. Audio subsystem 410 may include speakers, which comprise any system, device, or apparatus configured to produce sound in response to electrical audio signal input. In some embodiments, a speaker may comprise a dynamic loudspeaker, which employs a lightweight diaphragm mechanically coupled to a rigid frame via a flexible suspension that constrains a voice coil to move axially through a cylindrical magnetic gap such that when an electrical signal is applied to the voice coil, a magnetic field is created by the electric current in the voice coil, making it a variable electromagnet. The coil and the driver's magnetic system interact, generating a mechanical force that causes the coil (and thus, the attached cone) to move back and forth, thereby reproducing sound under the control of the applied electrical signal coming from the amplifier.

In certain embodiments, chipset 402 may further provide an interface for communications with one or more hardware sensors 411. Sensors 411 may be disposed on or within the chassis of IHS 400, or otherwise coupled to IHS 400, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), and/or acceleration sensor(s).

A Basic Input and Output System/Unified Extensible Firmware Interface (BIOS/UEFI) 412 is coupled to chipset 402. UEFI was designed as a successor to BIOS, and many modern IHSs utilize UEFI in addition to or instead of a BIOS. Accordingly, BIOS/UEFI 412 is intended to also encompass a UEFI component. BIOS/UEFI 412 provides an abstraction layer that allows the OS to interface with certain hardware components that are utilized by IHS 400. Upon booting of IHS 400, host processor(s) 401 may utilize program instructions of BIOS 412 to initialize and test hardware components coupled to IHS 400, and to load a host OS for use by IHS 400. Via the hardware abstraction layer provided by BIOS/UEFI 412, software stored in system memory 406 and executed by host processor(s) 401 can interface with I/O devices coupled to IHS 400.

An Embedded Controller (EC) 413 (sometimes referred to as a Baseboard Management Controller or “BMC”) includes a microcontroller unit or processing core dedicated to handling selected IHS operations not ordinarily handled by host processor(s) 401. Examples of such operations may include, but are not limited to: power sequencing, power management, receiving and processing signals from a keyboard or touchpad, as well as other buttons and switches (e.g., power button, laptop lid switch, etc.), receiving and processing thermal measurements (e.g., performing cooling fan control, throttling CPUs and GPUs, controlling colling fan speeds, and emergency shutdown), controlling indicator Light-Emitting Diodes (LEDs) (e.g., caps lock, scroll lock, num lock, battery, ac, power, wireless LAN, sleep, etc.), managing the battery charger and the battery, enabling remote or Out-of-Band (OOB) management, diagnostics, and remediation over network(s), and the like.

Unlike other devices in IHS 400, EC 413 may be made operational from the very start of each power reset, before other devices are fully running or powered on. As such, EC 413 may be responsible for interfacing with a power adapter to manage the power consumption of IHS 400. These operations may be utilized to determine the power status of IHS 400, such as whether IHS 400 is operating from battery power or is plugged into an AC power source. Firmware instructions utilized by EC 413 may be used to manage other core operations of IHS 400 (e.g., turbo modes, maximum operating clock frequencies of certain components, etc.).

In some cases, EC 413 may implement operations for detecting certain changes to the physical configuration or posture of IHS 400 and managing other devices in different configurations of IHS 400. For instance, when IHS 400 as a 2-in-1 laptop/tablet form factor, EC 413 may receive inputs from a lid position or hinge angle sensor 411, and it may use those inputs to determine: whether the two sides of IHS 400 have been latched together to a closed position or a tablet position, the magnitude of a hinge or lid angle, etc. In response to these changes, the EC may enable or disable certain features of IHS 400 (e.g., front or rear facing camera, etc.).

In some implementations, EC 413 may be installed as a Trusted Execution Environment (TEE) component to the motherboard of IHS 400. Additionally, or alternatively, EC 413 may be further configured to calculate hashes or signatures that uniquely identify individual components of IHS 400. In such scenarios, EC 413 may calculate a hash value based on the configuration of a hardware and/or software component coupled to IHS 400. For instance, EC 413 may calculate a hash value based on all firmware and other code or settings stored in an onboard memory of a hardware component.

In addition, EC 413 may provide an Out-of-Band communication channel that allows an Information Technology Decision Maker (ITDM) or Original Equipment Manufacturer (OEM) to manage IHS 400’s various settings and configurations, for example, by issuing OOB commands.

In various embodiments, IHS 400 may be coupled to an external power source through an AC adapter, power brick, or the like. The AC adapter may be removably coupled to a battery charge controller to provide IHS 400 with a source of DC power provided by battery cells of a battery system in the form of a battery pack (e.g., a lithium ion or “Li-ion” battery pack, or a nickel metal hydride or “NiMH” battery pack including one or more rechargeable batteries). Battery Management Unit (BMU) 414 may be coupled to EC 413 and it may include, for example, an Analog Front End (AFE), storage (e.g., non-volatile memory), and a microcontroller. In some cases, BMU 414 may be configured to collect and store information, and to provide that information to other IHS components.

Examples of information collectible by BMU 414 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information or state (e.g., such as ambient temperature, relative humidity, system geolocation measured by GPS or triangulation, time and date, etc.), events, etc. Examples of events may include, but are not limited to: acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, IHS 400 may not include all the components shown in FIG. 4. Furthermore, some components that are represented as separate components in FIG. 4 may instead be integrated with other components, such that all or a portion of the operations executed by the illustrated components may instead be executed by the integrated component. For example, in various embodiments described herein, host processor(s) 401 and/or other components shown in FIG. 4 (e.g., chipset 402, display controller(s) 404, communication interface(s) 403, EC 413, etc.) may be replaced by other devices. As such, IHS 400 may assume different form factors including, but not limited to: servers, workstations, desktops, laptops, appliances, video game consoles, tablet computers, smartphones, etc.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A method, comprising:
generating a symmetric cryptographic key over a public channel between a control plane and a voucher service;
generating, by the voucher service, a manufacturer keypair;
encrypting, by the voucher service, the manufacturer keypair using the symmetric cryptographic key;
transferring an encrypted manufacturer keypair from the voucher service to the control plane; and
decrypting, by the control plane, the encrypted manufacturer keypair using the symmetric cryptographic key.

2. The method of claim 1, wherein the voucher service and the control plane are not connected by a secure communication channel.

3. The method of claim 2, wherein the voucher service and the control plane are air gapped.

4. The method of claim 1, wherein the encrypted manufacturer keypair is transferred via email.

5. The method of claim 1, further comprising:
replacing the motherboard on a device; and
creating, by a manufacturer service on the control plane, a new voucher for the device, wherein the new voucher is associated with a replacement motherboard.

6. The method of claim 5, further comprising:
uploading the new voucher from the control plane to the voucher service;
identifying, by the voucher service, an original voucher associated with the device; and
attaching, by the voucher service, an original voucher identifier to the new voucher.

7. The method of claim 1, further comprising:
installing a control plane by a user;
receiving, by the user, an access token from the control plane; and
uploading, by the user, the control plane access token to the voucher service as a voucher download request.

8. The method of claim 7, further comprising:
receiving, by the user, a voucher from the voucher service; and
uploading, by the user, the voucher to the control plane to complete a device initialization recovery.

9. The method of claim 8, wherein the voucher is received by the user via email.

10. The method of claim 8, wherein the voucher is associated with a device having a replacement motherboard.

11. The method of claim 8, wherein the voucher includes an original voucher identifier associated with the device prior to the motherboard replacement.

12. The method of claim 1, further comprising:
assigning, by the voucher service, a unique manufacturer keypair to each of a plurality of users; and
transferring, by the voucher service, the user’s unique manufacturer keypair to the control plane when each user installs the control plane.

13. The method of claim 1, further comprising:
deleting the symmetric cryptographic key after the encrypted manufacturer keypair has been decrypted.

14. An apparatus, comprising:
a processor; and
a memory coupled to the processor, the memory having program instructions stored thereon that, upon execution, cause the processor to:
generate a symmetric cryptographic key with a control plane;
generate a manufacturer keypair;
encrypt the manufacturer keypair using the symmetric cryptographic key; and
send the encrypted manufacturer keypair to the control plane.

15. The apparatus of claim 14, wherein apparatus and the control plane are air gapped, and wherein the encrypted manufacturer keypair is transferred via email.

16. The apparatus of claim 14, wherein the encrypted manufacturer keypair is sent to a manufacturer service on the control plane, and wherein the manufacturer service is configured to generate device ownership vouchers.

17. The apparatus of claim 14, wherein the program instructions stored further cause the processor to:
receive a new ownership voucher from a manufacturer service on the control plane, wherein the new ownership voucher is associated with a device having a replacement motherboard;
identify an original voucher associated with the device; and
attach an original voucher identifier from the original voucher to the new ownership voucher.

18. The apparatus of claim 17, wherein the program instructions stored further cause the processor to:
send the new ownership voucher to a user, wherein the new ownership voucher includes the original voucher identifier, a manufacturer service signature, and a voucher service signature.

19. The apparatus of claim 14, wherein the program instructions stored further cause the processor to:
generate a unique manufacturer keypair for each of a plurality of users; and
transfer each user’s unique manufacturer keypair to the control plane when each user installs the control plane.

20. A computer program product comprising a non-transitory processor-readable storage medium having stored therein program code of one or more software programs, wherein the program code when executed by at least one processing device causes the at least one processing device to perform steps of:
generate a symmetric cryptographic key with an air-gapped control plane;
generate a manufacturer keypair;
encrypt the manufacturer keypair using the symmetric cryptographic key;
send the encrypted manufacturer keypair to a manufacturer service on the control plane, wherein the manufacturer service is configured to generate device ownership vouchers;
receive a new ownership voucher from the manufacturer service on the control plane, wherein the new ownership voucher is associated with a device having a replacement motherboard;
identify an original voucher associated with the device;
attach an original voucher identifier from the original voucher to the new ownership voucher; and
send the new ownership voucher to a user, wherein the new ownership voucher includes the original voucher identifier, a manufacturer service signature, and a voucher service signature.
